(19) United States
(12) Patent Application Publication
(10) Pub. No.: US 2014/0108494 A1
(43) Pub. Date: Apr. 17, 2014

(54) SYSTEM AND METHOD FOR ENABLING ONLINE SURVEYS USING A CLIENT SURVEY APPLICATION

(71) Applicants: Florian M. KAHLERT, Norwalk, CT (US); Brendon A. DAVIDSON, Austin, TX (US)

(72) Inventors: Florian M. KAHLERT, Norwalk, CT (US); Brendon A. DAVIDSON, Austin, TX (US)

(21) Appl. No.: 13/237,863

(22) Filed: Sep. 20, 2011

Related U.S. Application Data
(63) Continuation-in-part of application No. 12/770,644, filed on Apr. 29, 2010.
Application No. 12/770,644 is a continuation-in-part of application No. 12/770,662, filed on Apr. 29, 2010.
Application No. 12/770,662 is a continuation-in-part of application No. 12/770,670, filed on Apr. 29, 2010, now abandoned.
(60) Provisional application No. 61/320,689, filed on Apr. 2, 2010.
(60) Provisional application No. 61/320,689, filed on Apr. 2, 2010.
(60) Provisional application No. 61/320,689, filed on Apr. 2, 2010.

(51) Int. Cl. G06F 15/16

(52) U.S. Cl. 709/203

(57) ABSTRACT

A client survey application (or player) is configured to operate on a user (or respondent terminal). The client survey application is configured to communicate with a web service to receive survey data. The client survey application uses the survey data to present an interactive survey in connection with presentation of an online resource.

### RELATED APPLICATIONS

This application is (i) a continuation-in-part of U.S. patent application Ser. No. 12/770,644, filed Apr. 29, 2010, which claim benefit of priority to Provisional U.S. Patent Application No. 61/320,689, filed Apr. 2, 2010; (ii) a continuation-in-part of U.S. patent application Ser. No. 12/770,662, filed Apr. 29, 2010, which claim benefit of priority to Provisional U.S. Patent Application No. 61/320,689, filed Apr. 2, 2010; and (iii) a continuation-in-part of U.S. patent application Ser. No. 12/770,670, filed Apr. 29, 2010, which claim benefit of priority to Provisional U.S. Patent Application No. 61/320,689, filed Apr. 2, 2010. All of the aforementioned priority applications are hereby incorporated by reference in their respective entirety.

### TECHNICAL FIELD

Embodiments described herein pertain generally to a system and method for enabling online surveys.

### BRIEF DESCRIPTION OF THE DRAWINGS

FIG. 1 illustrates a system for presenting a survey integrated creative on a network page, according to one or more embodiments.

FIG. 2 illustrates an architecture for a system that provides survey-integrated creatives, according to one or more embodiments.

FIG. 3 illustrates an event sequence by which a system such as described with an embodiment of FIG. 2 can distribute survey-integrated creatives, under an embodiment.

FIG. 4 illustrates a method for providing a survey-integrated creative using a system such as described with an embodiment of FIG. 2.

FIG. 5A through FIG. 5H illustrate presentation of survey questions in a creative, according to an embodiment.

FIG. 6 illustrates a method in which survey-integrated creative includes video content, according to one or more embodiments.

FIG. 7A and FIG. 7B illustrate examples of video creatives, under an embodiment.

FIG. 8 illustrates an example of a tag that is triggerable to present a survey integrated creative on a web page, under an embodiment.

FIG. 9A though FIG. 9G illustrate interfaces for receiving input from a designer of a creative, according to one or more embodiments.

FIG. 10 illustrates a method for obtaining and using information from presenting survey integrated creative, according to one more embodiments.

FIG. 11 illustrates an architecture for a system that utilizes client survey applications to distribute survey-integrated creatives, according to one or more embodiments.

### DETAILED DESCRIPTION

Embodiments described herein pertain generally to a system and method for enabling online surveys. In particular, embodiments described herein provide a system and method for distributing survey integrated creatives on a network.

According to some embodiments, online interactive surveys are integrated with content to provide creatives, which are trafficked onto web sites. When rendered, the creatives display supplemental content and present interactive survey questions.

In some embodiments, resources for presenting the creatives are distributed onto a network that is remote to a survey site where the creatives are defined. Resources for presenting the creatives include a survey player, as well as data sets for presenting and defining survey and content components or portions of the creative.

In an embodiment, a survey site is used to (i) create a series of survey questions, and (ii) define a creative that includes supplemental content and one or more questions in the series questions. The creative is defined for a defined space or region on a web page. From the survey site, the creative is enabled to present questions from the survey with supplemental content. The supplemental content and the survey questions can then be rendered in a defined space of the creative.

In an embodiment, a survey tag is generated to identify data for presenting the creative. A survey player is triggered and operated to present defined creatives, including the supplemental content and the survey questions, on browsers that trigger the survey tag.

Still further, some embodiments enable creatives to use video (e.g. Flash) to present the supplemental content and/or survey questions of the creative.

As an addition or alternative, responses and user interactions to the creatives may be recorded in real-time. Moreover, some embodiments enable the responses to be recorded and transmitted to network locations specified by survey customers.

Embodiments described herein enable survey clientele (“survey designers”) to create survey projects that are integrated with commercial content. These creatives (the combination of survey projects and commercial content) are displayed on publisher sites as, for example, standard advertisement units, within video presentations or directly on a website. Embodiments further support multiple distribution methods for trafficking the creatives. For example, the creatives can be trafficked by placing project tags that call the creatives with an advertisement service. Alternatively, the project tags can be directly integrated into a media file (e.g. video) or web site resource. Users and visitors exposed to the survey can respond to the questions. The responses, including answers and non-answers to the survey questions, can be recorded and communicated to a variety of locations, such as a centralized database at a survey site.

According to embodiments, a survey site may generate a survey-integrated creative. The survey site can generate the project based on input received from a survey designer. The input can specify aspects of the creative, such as the survey questions, the sequence in which the questions are to be presented, the commercial content, and other information. The creatives can be trafficked as conventional network advertisement media (e.g. banner ads) in that the survey portions of the creatives are presented in the space of the creatives (e.g. where the ad unit is presented), avoiding the need to navigate the user away from the site, or generate overlays or pop-ups. Resources on the survey site generate a tag for the creative, similar to tags used for publishing online advertisements. A tag for a creative can be trafficked to advertisement services or servers, distributed onto publisher sites, or distributed through other network distribution mechanisms. In this regard, the creatives can be trafficked according to online campaigns established for the creatives, in a manner similar to distributing advertisement units such as conventional banner ads.

The creatives can be trafficked with resources that record the various responses from the users. According to some embodiments, responses to the creatives can be recorded in real-time, and associated with user identification information that enables survey responses to be associated with a profile (e.g. past user responses) for that user.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures belowprovide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

A “creative” includes survey content that is provided within a defined dimension or space of a web page. In many applications, the creative includes a combination of supplemental and survey, presented in a common space or dimension of a webpage. Examples of creatives include promotional or advertisement content that integrates survey questions.

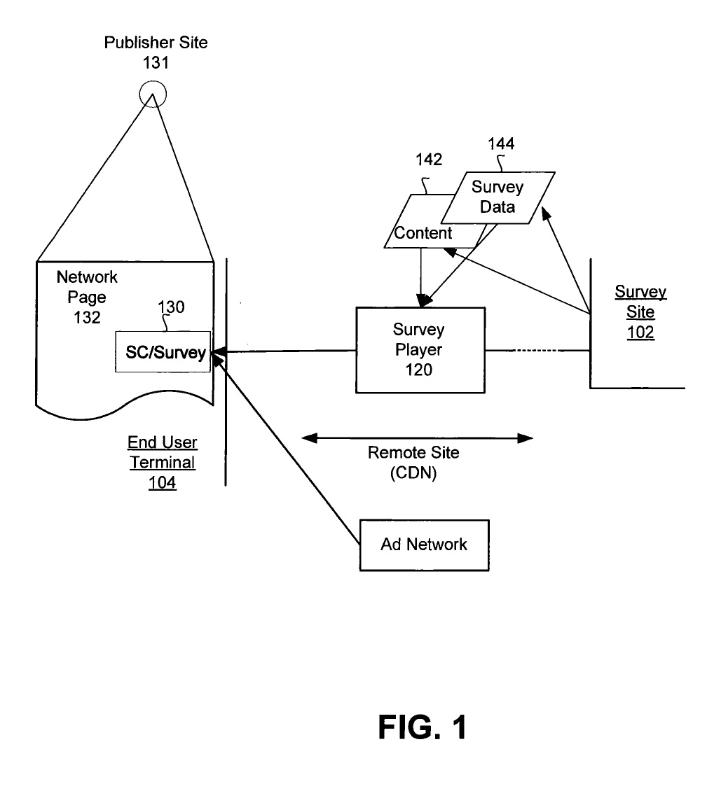

FIG. 1 illustrates a system for presenting a survey integrated creative on a network page, according to one or more embodiments. A survey site 102 generates or provides a survey player 120 from which survey-integrated creatives 130 are presented on individual web pages 132 hosted at publisher sites 131. The survey site 102 may be implemented by one or more computers, including, for example, a server to provide web interface and distribution of survey and content data. As such, the survey site includes processors, memory and network resources to interact with survey or creative designers and survey customers, and to provide interfaces and functionality for enabling creation, configuration and distribution of survey integrated creatives in a manner described. The end user terminal 104 may render web pages 132 on which the survey integrated creatives 130 are presented. The user terminal 104 may correspond to, for example, a personal computer, laptop, or mobile device. The device may render web pages 132 and creative 130 using a web browser, or web-enabled application.

In an embodiment shown, a creative 130 includes portion(s) corresponding to commercial or supplemental content 142, as well as a portion that corresponds to survey content 144; and both supplemental and survey content 142, 144 are defined to present in the same space of a web page. This space occupies a portion of the page 132. The survey player 120 presents the creative 130 to be interactive. Accordingly, the survey player 120 monitors the interaction of the user with the creative or survey content (e.g. detect the user electing to take a survey, detect a user answer to a survey question). As a variation, the creative 130 may include only or primarily the survey content 144, such as an invitation panel that leads into a series of survey questions. In either case, the survey player 120 records responses, such as the user electing to take a survey, or the user selecting specific answers to survey questions. The survey player 120 can present the creative 130 and record the user response(s) (if any) without navigating the user off the page (e.g. loading a pop-up page), or altering the presence or size of the creative that contains the survey content.

According to at least some embodiments, the survey site 102 generates data corresponding to the supplemental and survey contents 142, 144. This data may be generated from data and input supplied by the survey designer. Still further, in an embodiment, the survey player 120 operates from a location remote to the survey site 102 to generate and present the creative 130 using the data of the supplemental and survey content 142, 144. The creative 130 is distributed as part of a campaign that is provided for specific network sites or locations, as well as in accordance with pre-arranged schedules. When rendered on a terminal 104 that accesses the publisher site 131, one embodiment provides that the creative presents commercial content (e.g. advertisements or promotions), as well as survey content (e.g survey questions/answers). The survey portion of the creative 130 is interactive, so interactions such as responses to survey questions are detected and recorded. Additionally, the creative 130 is limited to a defined space or portion of the publisher's web page. As such, the creative 130 serves to supplement primary content of web page 132 by providing the commercial content and the survey content in a common designated space or portion of the web page. For example, the creative 130 can be presented as a banner ad, so as to occupy a predefined dimension on the network page 132. In this form, the creative 130 includes text, image, animation, including commercial and survey content, provided in a small portion of the network page 132. For example, the user may be presented with survey questions in a defined space (e.g. banner ad space), and the user can interact with the survey questions (e.g. he or she can answer the question) by interacting with pixels contained in the defined space. Thus, the user is not navigated to another page or presented with a pop-up.

In other implementations, the creative 130 is presented as a video presentation. For example, the creative 130 can be presented as Flash content, occupying a designated region (e.g. video frame) of the network page 132. The video content of the creative 130 may transition or be combined with survey content, and the end user may interact with pixels contained within the frame of the creative in order to, for example, select answers to survey questions or otherwise interact with the survey portion of the creative 130.

In embodiments such as those that incorporate video, the survey player 130 can be implemented by a web page that uses a tag to call the survey player 130 from a remote network location (e.g. on the content delivery network or at the survey site). The survey player 130 loads onto the page and uses linked data sets to present associated content (e.g. Flash video) and survey content. In alternative variations, the web page uses a host player, which in turn calls the survey player 130. The survey player 130 presents the creative in the frame of the host player. On completion, the survey player 130 is destroyed.

According to an embodiment of FIG. 1, the survey site 102 includes resources to generate (i) content and survey data 142, 144 from which the corresponding creative 130 is generated, and (ii) the survey player 120. The survey player 120 uses the data to present the survey integrated creative 130 on various publisher web pages. In some embodiments, the survey site 102 includes functionality to interface with survey designers, in enabling survey designers to generate surveys (e.g. specify questions, specify candidate answers, sequence of questions) and integrate their surveys with commercial content (e.g. advertisements). In one implementation, the creative 130 is specified for an advertisement campaign, so that the creative presents both advertisement content (or other supplemental content) and survey content. As described with other embodiment, the creative 130 occupies a designated or limited space on the web pages, and the survey content appears in the same space as the promotional content.

The survey portion 144 of the creative 130 includes questions (including choice of answers), as well as metadata that determines characteristics such as (i) sequence in which questions are presented, (ii) triggers to present one or more of the questions, (iii) duration in which individual questions are presented, and/or (iv) the manner in which the creative is closed or terminated. The supplemental content portion 142 includes content that is used in the creative 130 (e.g. presentation of ad banner). For example, the content portion 142 can include Flash content used to present advertisement on a web page, or include a link or pointer to locating the designated creative on an advertisement service or remote server. The content portion 142 and survey content 144 can be provided as files or data sets stored on a network or on the survey site 102. In some variations, the content portion 142 of the creative 130 can be provided as a link that is associated with the survey portion 144. The link may, for example, identify a particular banner advertisement hosted on a network advertisement service.

According to some embodiments, the survey player 120 is implemented as one or more programmatic components that are distributed or provided from the survey site 102. In an embodiment, the survey player 120 executes on the rendered web page to provide the creative 130 using the data for the content portion 142 and the survey portion 144. In one implementation, the survey player 120 resides on the network, such as with the publisher's site and/or on a content delivery network. When executed, the survey player 120 presents the creative 130 in the defined space of the web page. For example, the survey player 120 locates and presents ad content (e.g. banner advertisement and/or video content) specified with the creative 130 using the data of the content and survey portions 142, 144. From the location (remote to the survey site 102), survey player 120 is able to detect and record responses to the creative 130 from the end viewer.

As an alternative, the survey player 120 may be implemented at the survey site 102 and communicate with web pages to provide the data corresponding to creative 130. The survey player 120 can also include code or scripts to enable it to record the user response to the survey portion at the survey site.

Architecture

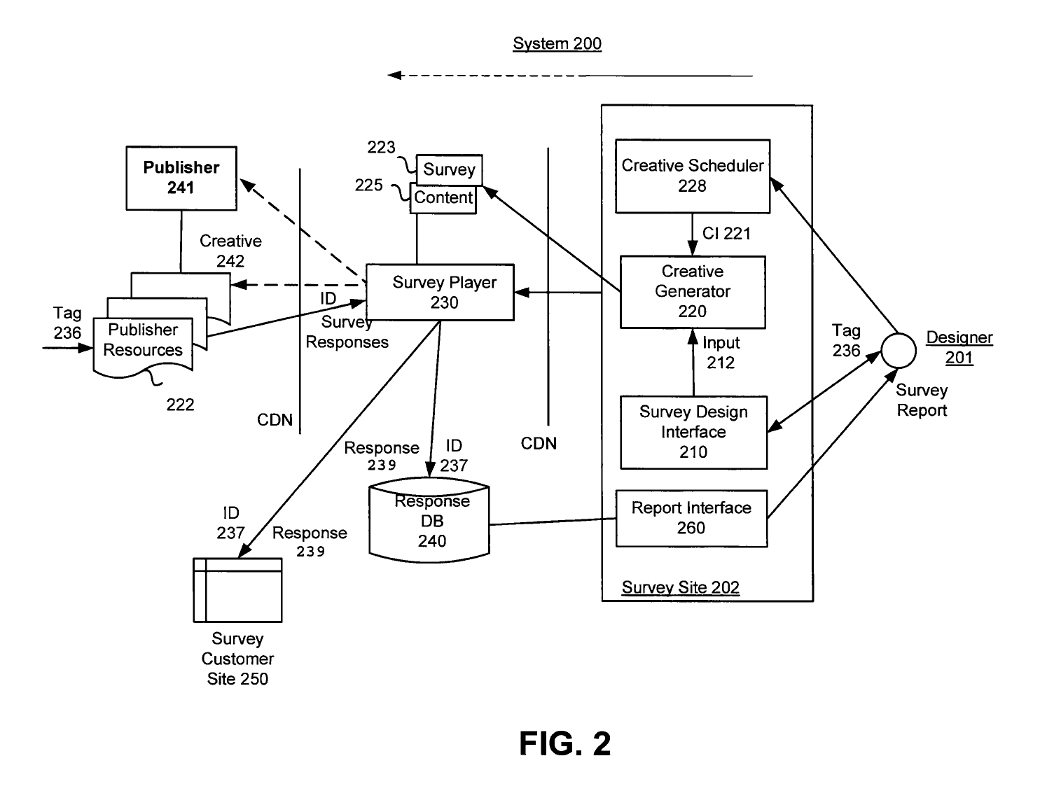

FIG. 2 illustrates an architecture for a system that provides survey-integrated creatives, according to one or more embodiments. A system 200 includes components or modules that operate on a survey site 202 to generate data that is rendered on web pages 222, or other resources of publishers, as survey-integrated creatives 242 (e.g. web page advertisements that integrate survey questions). System 200 also includes a survey player 230 that executes to provide interactive survey and content data to web pages 222. In an embodiment, system 200 is distributed, with components such as survey player 230 residing remote to the survey site 202. In one implementation, the survey player 230 resides on one or more locations of a content delivery network.

At survey site 202, system 200 includes a design interface 210, a creative generator 220 and a creative scheduler 228. The design interface 210 provide interactive functionality to enable a designer 201 to specify input 212 for creating and presenting creatives. The input may specify input for creating surveys, as well as supplemental content that is provided in connection with the survey presentation. With regard to the survey portion, the input 212 of the survey designer 201 can specify a series of survey questions, a set of candidate answers for each survey questions, information to specify sequence and/or timing of individual questions, and other metadata such as data that specifies how or when the first question in the sequence of survey questions is to be presented and how the presentation of the survey is to end. The design interface 210 also enables the designer to specify the supplemental content portion of the creative, including the commercial content that is to be used with a particular survey. The design interface 210 can be implemented as a web interface, and the survey designer 201 can interact with the interface using a web browser.

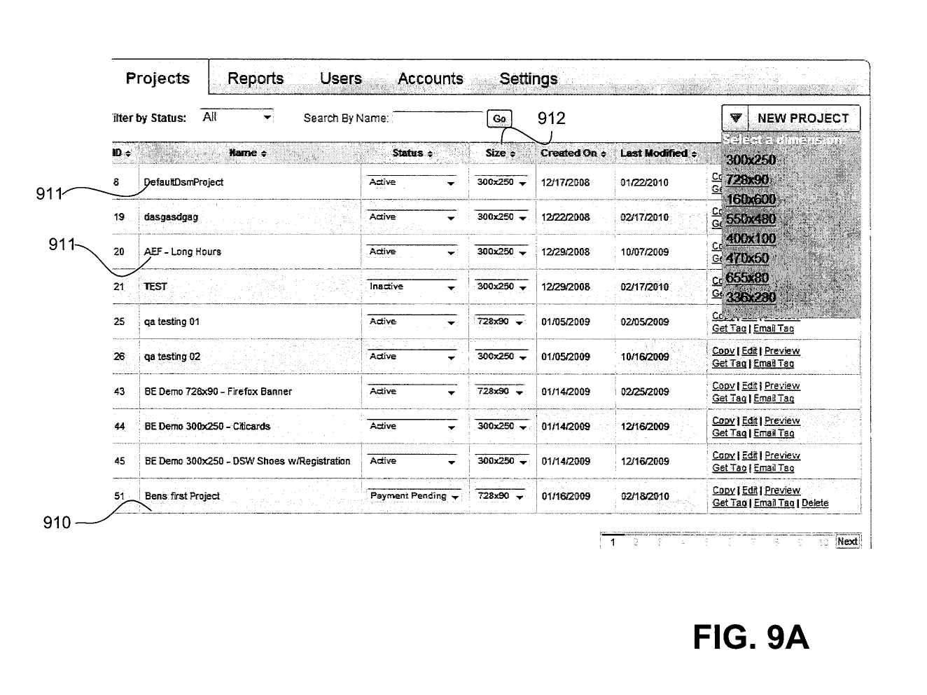

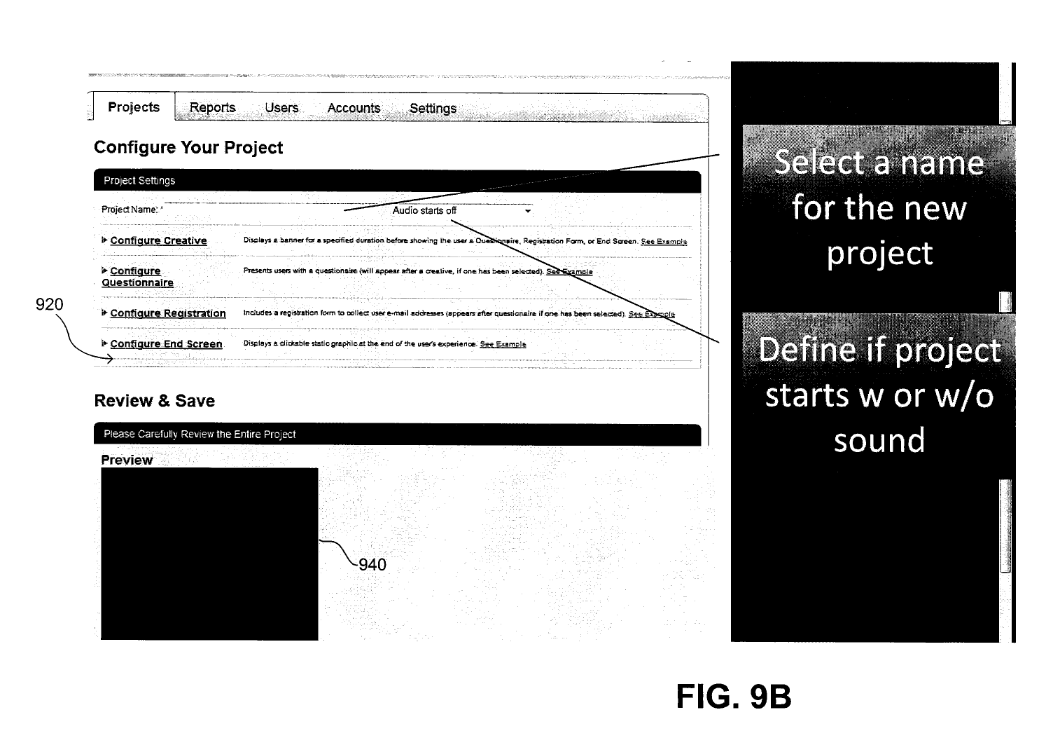

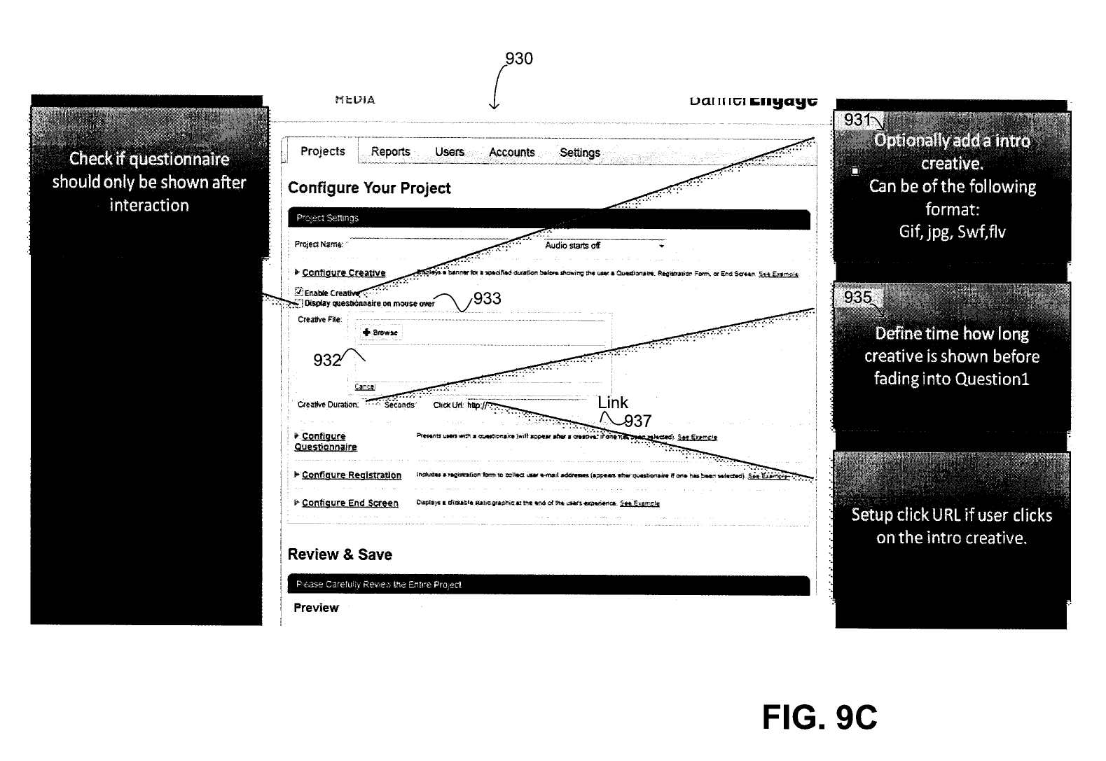

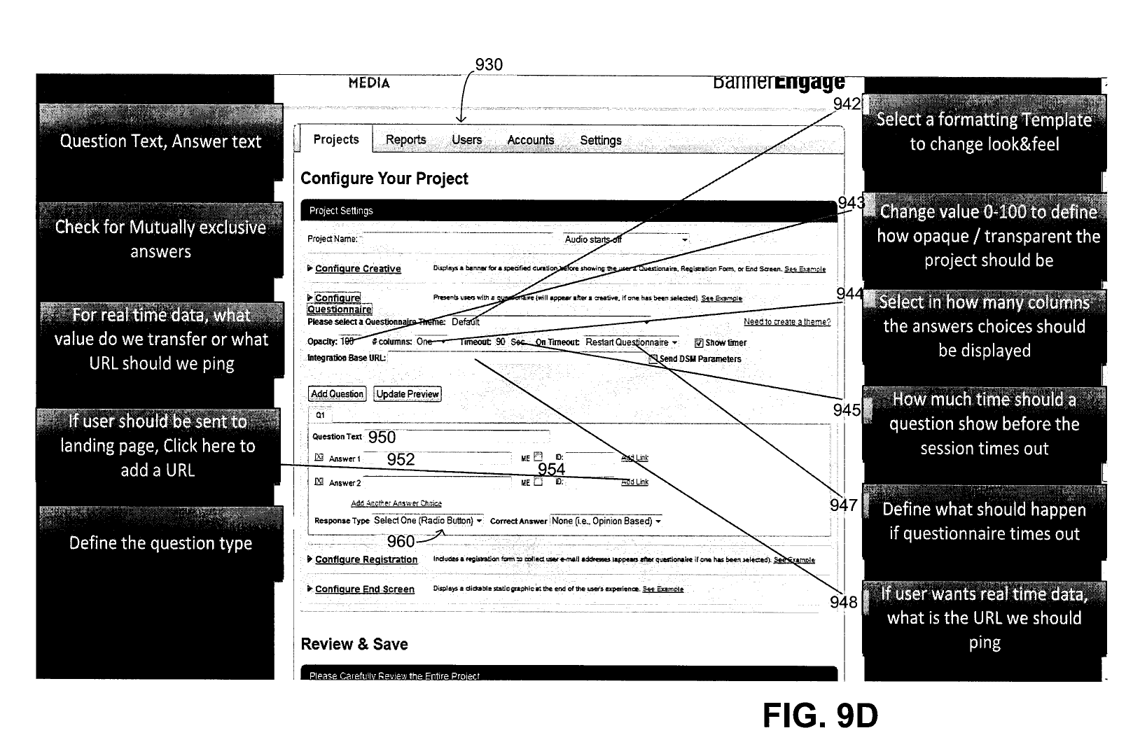

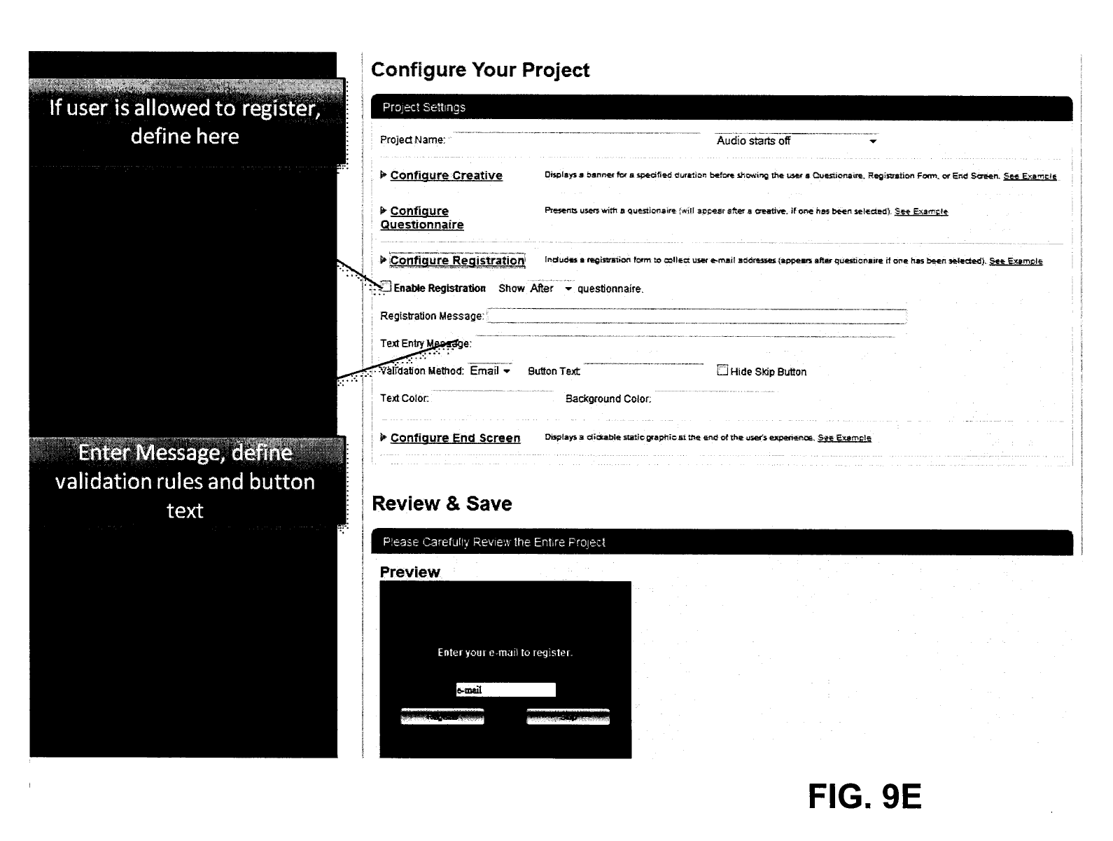

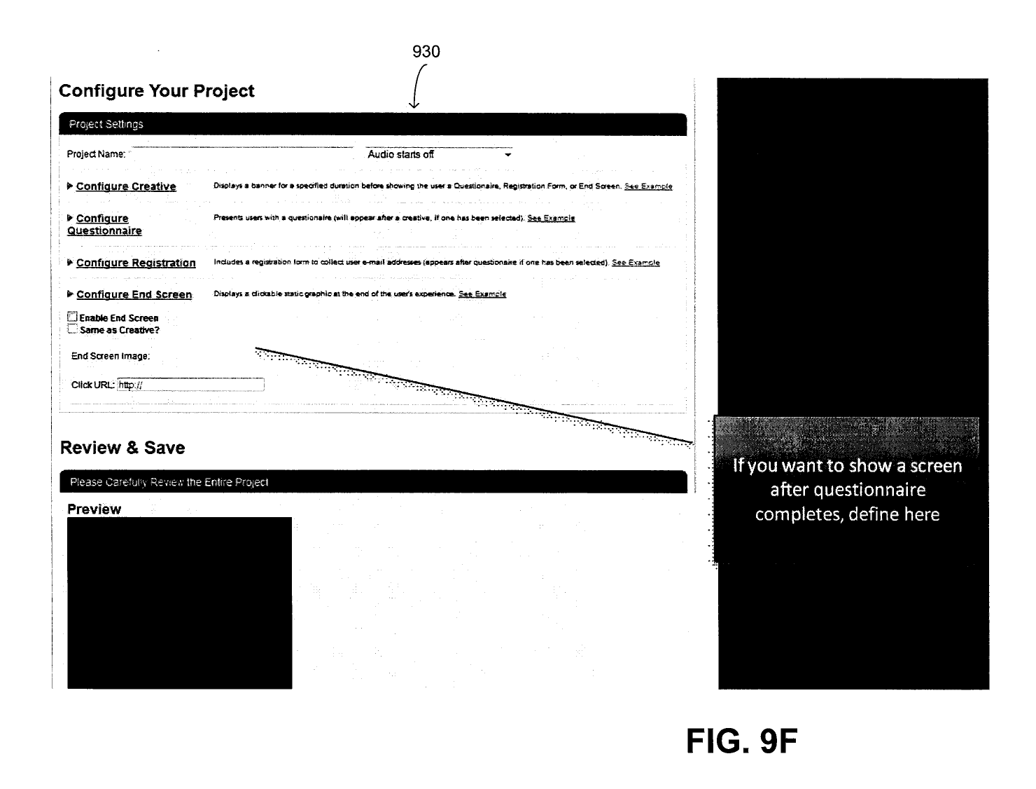

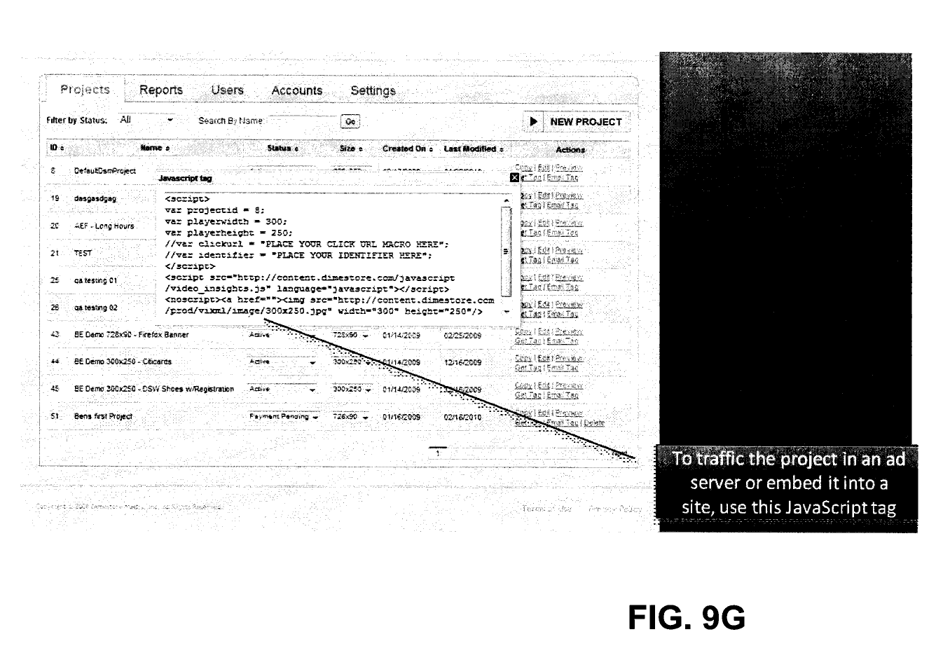

The creative generator 220 generates data sets that are used by the survey player 230 to present creatives 242 on the web pages 222. The data sets for a particular creative 242 include survey data 223 and the associated data set 225. According to some embodiments, the creative generator 220 locates the survey data 223 and the content data 225 on the network (remote the survey site 202), where it is linked with the survey player 230. The associated data set 225 may include, for example, XML data that defines the space of the creative and other parameteric information (e.g. see also FIG. 9A through FIG. 9G). In some implementations, the associated data set 225 specifies events and/or timing for triggering progression of the creative. The event/timing progression of the creative includes one or more of the following: (i) display survey invitation or supplemental content when webpage is rendered; (ii) transition from content portion to survey portion (e.g. after duration or when user clicks the creative); (iii) transition to next question in the survey; and/or (iv) complete or terminate the survey portion of the creative.

The survey player 230 can be triggered by the web pages 222 to use the data sets 223, 225 to present individual creatives 242. The creatives 242 (i) present supplemental commercial content, such as advertisements, in standardized units typical of ‘banner ads’; and (ii) a sequence of questions that the user can answer in the space of the creative. The creatives 242 thus integrate or merge the survey questions with the supplemental content so that the presentation of the survey questions does not require a pop-up, an overlay, or navigation of the user's browser to another web page where the survey is actually performed. An embodiment such as shown by FIG. 2 enables the survey-integrated creatives generated from the survey site 202 to be implemented in campaigns using infrastructure (such as ad networks) that are in existence today for standard online advertisement units such as banner ads. Survey site 202 may also operate a scheduler 228, to enable the designer 202 to specify campaign information 221, such as number of required impressions, or the period in time for which the creatives are to be presented.

In some embodiments, system 200 uses tag 236 to trigger the survey player 230 into presenting a particular creative 242 on a publisher site. The tag 236 may be outputted to the designer 201 for manual inclusion in the web pages 222 of the publisher site(s). The tag 236 can also be trafficked using services, such as advertisement networks. When the creative 242 is rendered as part of a web page, the tag 236 is used to locate and trigger the survey player 230. The tag 236 also specifies the particular creative that is being triggered. When triggered, the survey player 230 locates and uses the data sets 223, 225 of the specific creative 242 to present the contents of the particular creative 242 on the triggering web page 222. The survey player 230 presents the content in an interactive fashion. Thus, the survey player 230 operates to record responses from end users who view the creative 242. The responses can include (i) the user performing an action (click or hover with pointer) that is designed to trigger the presentation of survey questions in the space of the creative (e.g. following the presentation of commercial content); (ii) record input from the user in response to be presented questions. For example, individual survey questions can include a set of candidate answers, from which the user is to select a best answer. The player 230 may record the user's selection, which can be in form of pointing and clicking the user's selected candidate answer, the user hovering over the particular answer, or the user typing in his or her answer.

Response data 239, corresponding to individual responses to the survey portion of individual creatives 242, are recorded and communicated to a database 240 that retains the responses. The survey database 240 may be part of the system 200 provided with the survey site 202.

As an addition or alternative, the survey response data 239 can be communicated directly from the end user terminal to a survey customer site 250. In one implementation, the survey player communicates the responses to the survey customer site 250. The response data 239 may record affirmative responses to some or all of the survey questions (e.g. affirmative responses to presented survey questions), as well as non-responses (e.g. user answers only some question or non of the questions). Additionally, in some embodiments, the response data 239 may carry identification information 237 that identifies information about the respondent. This information may be programmatically determined (e.g. using a cookie) from the terminal of the respondent and/or manually provided from the respondent (e.g. email address) the user terminals from which the responses were recorded. The identification information may serve to match the specific user's responses from one survey to responses from the same user (or terminal) to another survey, thus enabling the customer survey site to record multiple survey responses from one user.

As an alternative or addition to identification information, the response data 239 may include other information, including dynamic information that is provided or determined from the website publisher, an advertisement server, or another source. This information can be contextual or non-demographic. For example, the publisher website may identify the website that provided the creative for which the survey response has been provided, and this information may be communicated with the response 236. Alternatively, the publisher site or another service (e.g. advertisement service) can identify the time and day that a particular survey response 239 was provided.

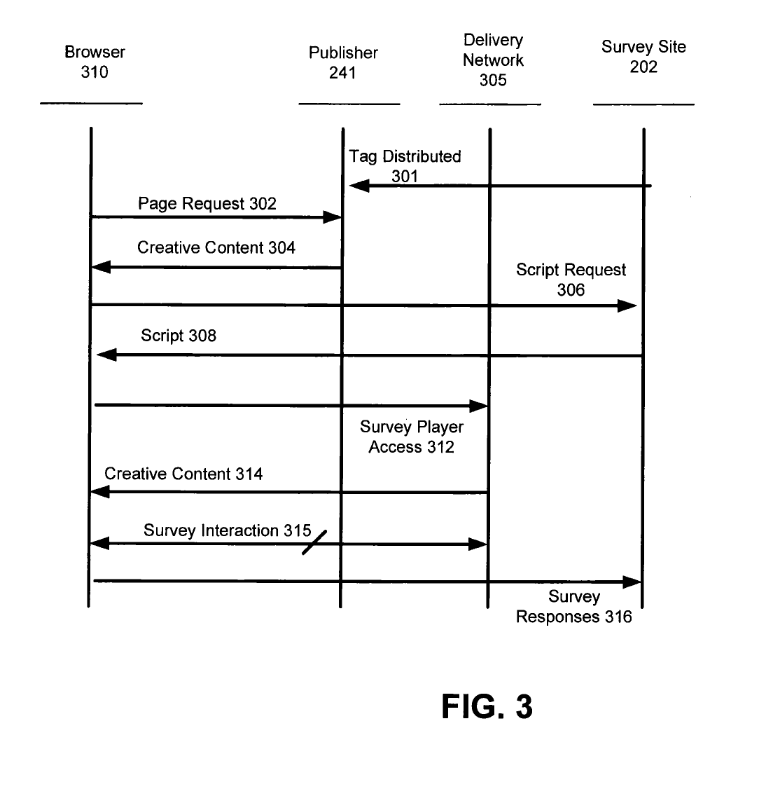

FIG. 3 illustrates an event sequence by which a system such as described with an embodiment of FIG. 2 can distribute survey-integrated creatives, under an embodiment. Reference is made to elements of FIG. 2 for purpose of illustration. More specifically, FIG. 3 illustrates a sequence of events carried out between survey site 202, publisher site 241, content delivery network 305 and end user browser 310, that result in presentation and use of a survey-integrated creative on browser 310. From survey site 202, tag 236 is generated and provided to the publisher site 241 (301). In some embodiments, the tag 236 is manually placed with the publisher site 241. The browser 310 signals a page request (302) from the publisher site 241, and the publisher site 241 returns page content (304) to the browser 310. The page content includes the tag 236, which triggers the browser 310 to request a script (306) from the survey site 202. The survey site 202 returns the script (308).

The browser 310 then uses the script to access the survey player 230 (312), and the associated data sets 223, 225 for a particular creative identified by the tag 236. As mentioned with other embodiments, the survey player 230 may reside on the network, rather than with the survey site 202. The player 230 returns the contents of the creative 242 (314), which include the creative's commercial content, as well as the sequence of questions that comprise the creative's integrated survey. A series of interactions (315) may follow if the user elects to answer any of the questions that comprise the survey. Survey responses are recorded at the survey player 230 and communicated (316) to either the survey site 202 or to an external site.

By locating the survey player 230 on the network, rather than with the survey site 202, the communications for rendering the creative (314) and subsequent interactions (315) are seamlessly promoted as part of the rendering web page. The location of the survey player 320 on, for example, a content delivery network significantly reduces the network resources required from the survey site 202, as well as reducing the network distance between individual end users (and survey respondents) and the mechanism that controls the presented survey questions. Thus, the user experience in answering questions is greatly enhanced.

Methodology

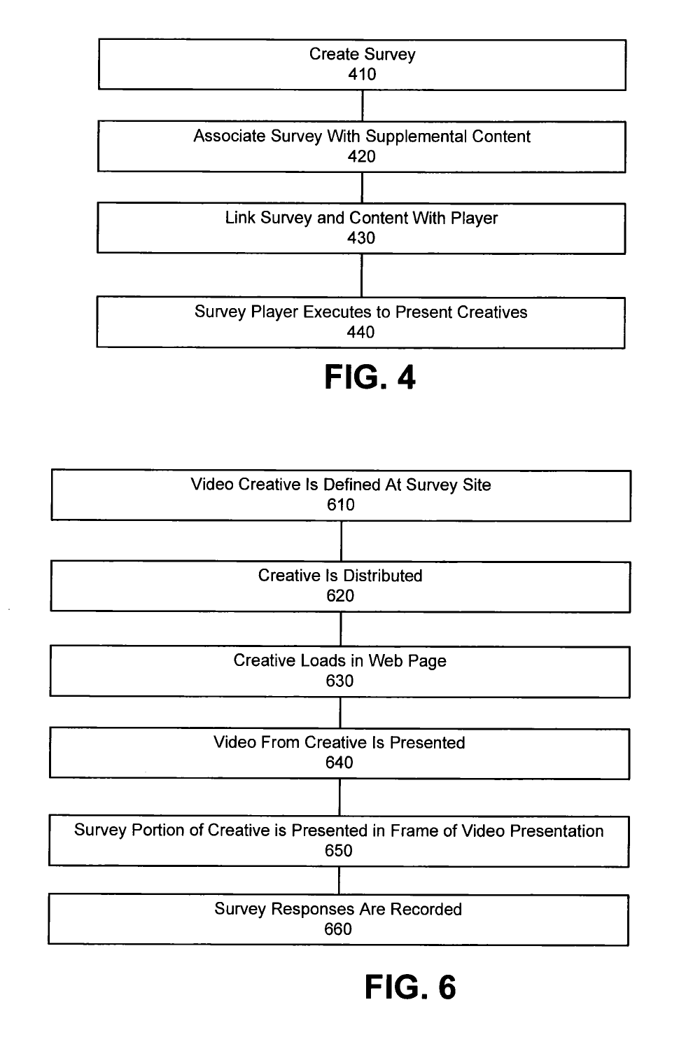

FIG. 4 illustrates a method for providing a survey-integrated creative using a system such as described with an embodiment of FIG. 2. In describing an embodiment of FIG. 4, reference is made to elements of FIG. 2 for purpose of illustrating a suitable element or component for performing a step or sub-step being described.

On a survey site, a designer creates a survey (410). In an embodiment, designer 201 specifies survey questions to design interface 210 at the survey site 202. The survey questions may include the question component (e.g. “Do you drive a car?”) and the answer component (candidate answers, such as “Yes” and “No”). The designer input may specify, for example, the order or sequence for a set of questions, as well as the manner in which the questions or to integrate with the content. For example, the designer input can specify the manner in which the set of survey questions are to end.

In an embodiment, the designer 201 builds a project by first uploading the content portion of the creative to the survey site 202. The content portion of the creative can correspond to, for example, an image, an object or media file (e.g. Flash video) that corresponds to supplemental commercial content. For example, the supplemental commercial content may correspond to a video commercial or banner advertisement. The creative designer also specifies the survey portion of the creative. This includes (i) defining one or more questions that the user is to answer, (ii) presenting options or candidate answers for the user to select from. The user may also specify survey parameters such as whether the question is a single-select (i.e. accepts one answer), multi-select question (i.e. accepts more than one answer), open-ended question (e.g. user types in the response), or other type of question. Other input for presenting the survey portion include (i) input to define the look and feel of the survey questions, (ii) input for defining the behavior of the creative to certain user actions or non-actions. In the latter case, the creative designer may specify, for example, whether the survey portion and/or creative is to close after a period of inactivity, or whether the survey portion is to be triggered into being presented by some user action (e.g. pointer hovering). As another variation, the survey designer may specify that the survey behavior is to include skipping certain questions based on answers to previous questions. For example, some networks require survey respondents to be of a certain age. In such cases, the first question of the survey may be to ask the respondent's age, and if the respondent is below the threshold age, to cause the survey to skip to its last panel (e.g. a thank you panel).

Still further, input from the user may include providing a registration page where the respondent can register himself and be identified. The input can also include an end screen for when the survey is complete.

The survey is associated with supplemental content (420). The user may specify the supplemental content by directly providing the content to the interface, or by associating the survey with supplemental content provided from another source. In the latter case, for example, the user can provide a link to an ad network file that contains the supplemental content. In one embodiment, the survey questions and the supplemental content are distributed on the network as data sets.

The survey and the supplemental content are linked to a survey player that presents the creative as an interactive element on web pages (430). In one embodiment, the link is accomplished using a tag that enables the browser or end user terminal to locate the survey player 230 and the associated data set. When the tag is triggered, the survey player executes on a network to present the creative that comprises the survey and the supplemental content (440).

According to some embodiments, the tag is triggered as follows: the tag causes the end viewer browser to make a call to the survey site. The survey site returns to the end user terminal a script to enable the terminal to locate the survey player 230 on the network and to identify the particular creative that is to be rendered. When the user terminal executes the script, the browser communicates with the survey player 230 to receive the data sets of the creative. In one implementation, the survey player 230 loads the supplemental content portion of the creative along with the survey portion, so that the creative is presented in a defined space or region of the web page, and both the content and the survey questions appear in that defined space.

Numerous implementations for presenting the creative are possible. For example, the supplemental or promotional content can correspond to an image, text, dynamic media or animation, or video (e.g. Flash). The survey portion may automatically appear in the creative concurrently, subsequently or before the presentation of the supplemental content. Still further, the survey portion can automatically appear (e.g. after the content is presented), or be contingently displayed in response to an event, such as the user hovering a pointer object or selecting to see the survey portion. Still further, all viewers may be presented a first question, such as one that asks whether they wish to take the survey, and the remainder of the survey questions may be asked if the user answers to take the survey. Other implementation and variations may also be used, some of which are described herein.

Creative Example

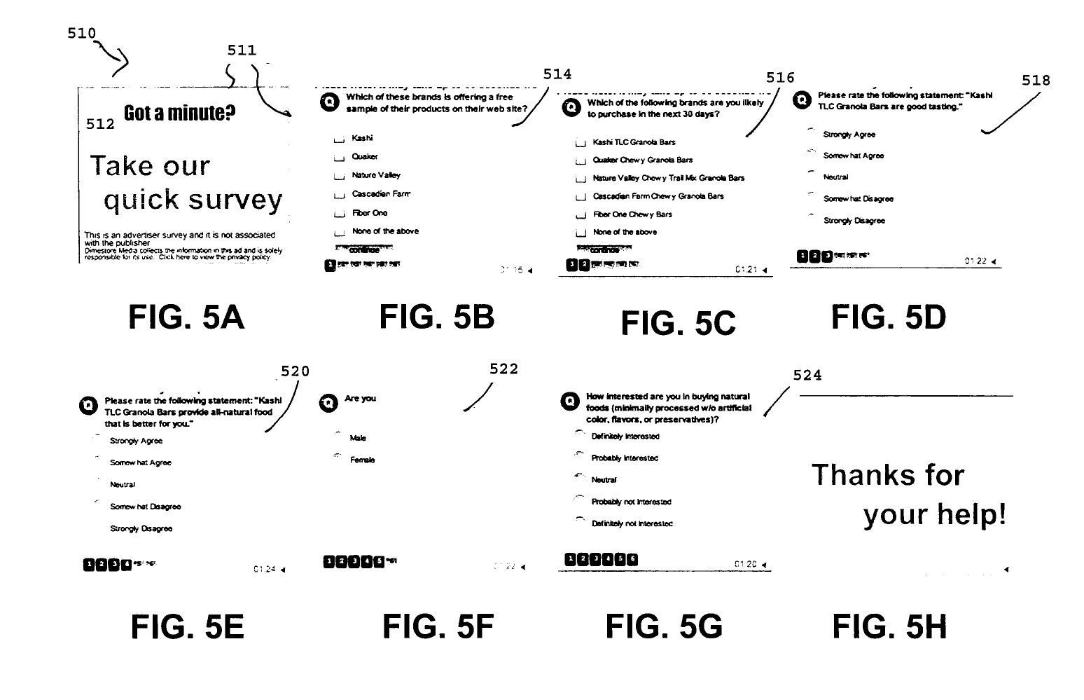

FIG. 5A through FIG. 5H illustrate presentation of survey questions in a creative, according to an embodiment. A creative 510 is generated in a web page, for example, to supplement other content provided with the web page. The creative 510 includes a dimension and boundary 511, which can be set so that the creative occupies a designated proportion of the web page or portion thereof. The survey portion of the creative 510 can be timed to follow promotional content, which can be presented as an image, text, dynamic media, or video. Still further, some embodiments provide that the creative 510 includes no content other than the survey portion.

The survey portion can be designed by the designer, and include various different facets or variations. The designer, for example, may specify that the survey is to run only if a certain condition occurs. Still further, FIG. 5A illustrates an implementation in which the survey runs within the creative only if the end user performs some action (e.g. mouse-over on the creative) that is designated to trigger an initial question (e.g. an invitation to participate in the survey). Thus, a first panel 512 of the creative is a welcome or invitation. The user response to the initial question may be by way of, for example, (i) clicking on the creative, (ii) hovering on the creative, (iii) non-action, and (iv) typing or selecting an answer that affirms their interest in taking the survey.

In the example shown, a series of panels 514-524 follow the initial panel, each carrying a question of the survey portion. The questions may each include two components: (i) survey question, and (ii) a candidate set of possible answers, from which the user may select one answer (or in variations multiple answers, no answers, write-in an answer etc.). In other implementations, questions may be open-ended, so that the user can provide or enter in his answer. While an implementation shown provides for one question (survey question and candidate set of answers), other variations provide that more than one question may be provided on a panel.

According to some embodiments, the user is able to interact with each panel 514-524 in order to specify one or more answers to each of the survey questions. The user interaction may be by way of, for example, clicking a select answer, or performing some other action that indicates the user's selected answer. The individual user responses do not navigate the user away from the webpage that is presented. The particular panel shown may change, in that the question transitions to another question, but the panels are presented within the dimensions of the creative 510. Plus, the creative 510 may be static, while the contents change and enable user interaction: the creative 510 may initially show content, then transition to a series of panels that represent survey questions and invite user responses.

Additionally, panels that carry survey questions may require triggers in order to be displayed and/or transition to a next panel. For example, the first panel 512 may correspond to the invitation panel, and the first survey question panel 514 may follow the invitation panel only after the occurrence of some event, such as passage of time (e.g. three second) or user action (e.g. user clicks the invitation panel). To provide such functionality, the associated data set that is provided with the creative may include metadata that specifies the timing or the event that are to trigger the presentation of a first survey question, next survey question and/or last survey question. For example, the metadata may specify (i) one or more events (e.g. user action such as mouse-over or click, passage of time, user responds affirmatively to survey invitation) that trigger the start of the survey or the transition of the content to the survey, (ii) event or duration of time before a next question in the series is presented (e.g. upon the user answering the question and/or passage of time), and/or event or duration before the end of the survey portion of the creative. In some implementations, subsequent panel carrying survey questions (514-524) are triggered to replace the prior panel only if the user answers the survey question of the prior panel. In some variations, a panel that carries the survey question may transition to the next panel if a pre-determined duration of time passes.

The numerous variations as to how the survey panels and questions are presented, transitioned, and sequenced may be set by the designer of the survey. Thus, survey design interface 210 (see FIG. 2) may be configured to enable the user to specify parameters and configurations, such as those needed to implement any of the variations described above.

FIG. 5H illustrates a closing panel 530 that may be displayed when a user completes a survey. As described elsewhere, an embodiment provides that the designer 201 can select whether closing panel 530 is to appear, as well as its message or content.

Video Creatives

FIG. 6 illustrates a method in which survey-integrated creative includes video content, according to one or more embodiments. A method such as described can be implemented using system components such as described with FIG. 1 and FIG. 2, or elsewhere in this application. Accordingly, reference is made to elements or components described with other embodiments for purpose of illustrating suitable elements or components for implementing a step or sub-step being described.

As mentioned with some embodiments, the content specified for a creative can be a video object or file. A creative designer may specify a video advertisement that is formatted (e.g. Flash file) for presentation on a web page (610). The survey portion of the video creative can be specified in a manner described with other embodiments. For example, a designer may use a web based interface such as described with FIG. 9A through FIG. 9G, and then specify a video file or content for inclusion in the creative.

The creative is distributed to publisher resources, such as web pages (620). As described elsewhere, in some embodiments, the creative may initially be identified by a tag that results in the terminal that is loading the web page to access programmatic resources for rendering the creative.

When the publisher resource loads the web page, the creative is rendered (630). In some embodiments, the survey site 202 can host the programmatic resources that communicate with publisher resources to provide the video creative. In one implementation, the survey player incorporates a Flash or media player. The end viewer's browser may call the survey player, which may reside with the survey site or at an intermediary network location (e.g. on a content delivery network). The webpage is rendered and loads the survey player (e.g. the webpage has a script that calls the survey player). The survey player loads in the webpage using data that is specified by the script in order to render a particular video formatted survey integrated creative.

In another implementation, the webpage is provided a separate host media player. The webpage executes the script causing the media player (or webpage) to call the survey player. The survey player then runs in the host player and uses the data set specified by the script to render the video formatted creative. The survey player ends, triggering the host player to close the survey player.

When the creative is rendered, video from the creative is presented on the web page (640). The video is presented in a frame of the web page. For example, a video commercial may play on a segment of the web page.

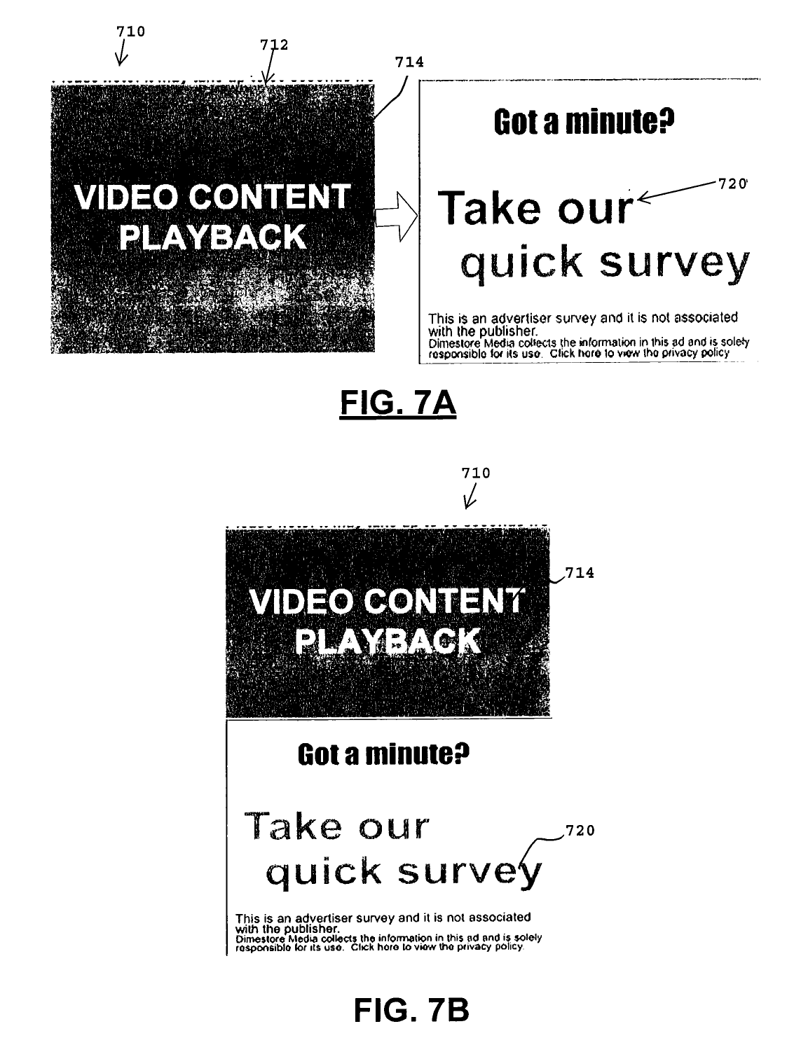

The survey portion of the creative is presented concurrently or subsequent to the video presentation (650). In one implementation, the video portion of the creative transitions into survey questions specified by the designer. FIG. 7A illustrates an example of such a video creative. The video creative 710 includes a frame 712 within which video playback of commercial content 714 (or other types of content) is provided. The video playback includes a transition sequence in which the survey content 720 follows the commercial content 714. The survey content 720 may also be presented in video format, although other implementations include providing the survey content 720 in image format. Various visual effects can be used to promote or facilitate the transition (e.g. fade of the commercial content 714 into the survey content 720). The rendering of the survey content, whether in video or any other format, may in some implementations be carried out such as described with the panels of FIG. 5A through FIG. 5H.

In other implementations, the video and survey portions of the creative may overlap in time when they are presented (see FIG. 7B). For example, the first question in the survey content 720 is presented at a time when the video content 714 is still ongoing, so that concurrency exists in the timing of the video and survey content. The timing and the manner in which the survey questions are presented can be selected or specified by the creative designer, or by other parameters.

The presentation of the survey questions may visually appear to be similar to that described with, for example, non-video implementations, with exception that the survey questions and answers are presented using either (i) video data format, or (ii) blended into a video format (e.g. augmented to end of video file). As with other embodiments, the presentation of survey questions may be sequenced, and configured with input or metadata such as (i) display questions in a sequence, (ii) display a next question only if a presented question is answered and/or after a designated duration; and/or (iii) initiate the survey (e.g. after the presentation of the content) only if an event occurs, such as mouse click or hover, passage of time, or the user answering affirmatively to being asked to answer a survey.

The responses to the survey portion of the creative can be recorded by the survey player or programmatic resources of the survey site (660). Thus, the video creative is interactive, in that an end user can respond to a survey question and have the particular response is recorded.

Tag Generation

According to some embodiments, web pages that are targeted to present survey integrated creatives are seeded with tags that then call code or functionality for (i) communicating with the survey player, (ii) identifying the particular creative that is to be used, and/or (iii) enabling the survey player to load or otherwise provide the content and survey data for the particular creative. As mentioned with an embodiment of FIG. 2, the tag may trigger the rendering terminal to access the survey site 202 in order to receive a script that it then executes to call the survey player 230 from a location on the network (remote to the survey site 202). The tag may also identify to the survey player 230 the particular creative that is to be rendered.

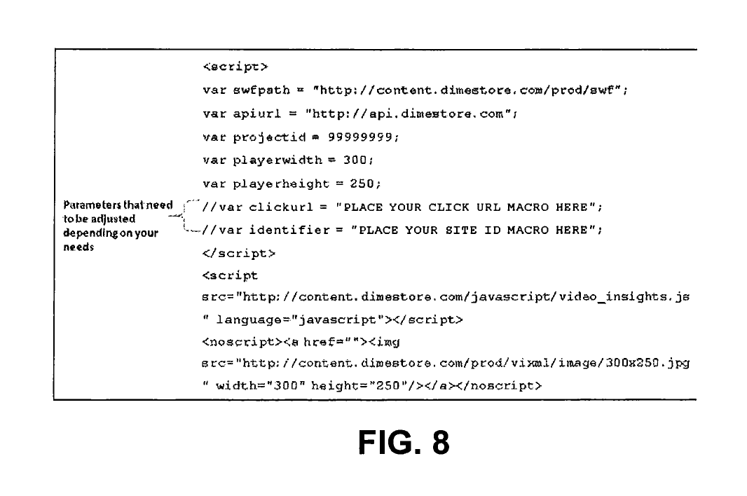

The tag generated from the survey site can correspond to, for example, a javascript tag, an iFrame tag, a coded URL, or a Flash container. The tag generated from the survey site includes portions that are predetermined and portions that are programmatically determined based on input from the survey creator. An example of a tag is illustrated in FIG. 8.

The tag can be generated for a publisher or advertiser to insert in a trafficking medium. The tag can also include encoding to monitor impressions or click-thrus. For example, with reference to FIG. 8, some variables in the tag can be manually set, such as “clickurl” and “identifier”. The clickurl variable can be updated to notify the hosting ad server of a click event so the hosting ad server can track clicks. As another example, the “var identifier” variable is used to forward a value into the survey sites output data set. The variable may be replaced by values that track responses by Site or Placement, so the siteID or placement ID can be dynamically inserted. The ID can also be manually set.

### Examples

| | |
|---|---|
| To add a fixed ID to the project: | var identifier=“Segment1”; |
| To add a DFA Placement ID | var identifier=“%epid!”; |
| To add a DFA SiteID | var identifier=“%s”; |
| To add a Atlas SiteID | var identifier=“%site_alias%”; |

According to some embodiments, the tags are output to a survey creator, who then can upload the tag to a third party advertisement server, publisher site server or other distribution resource. An example of a trafficking resource is ATLAS, a third-party ad server.

Designer Interface

FIG. 9A though FIG. 9G illustrate interfaces for receiving input from a designer of a creative, according to one or more embodiments. Interfaces such as shown can be generated using, for example, survey design interface 210, so as to form a part of a system such as shown with FIG. 2. Interfaces such as shown with FIG. 9A through FIG. 9G can be used to receive input from survey designer 201, in order to receive input that identifies content and survey questions for each creative, as well as other configurations such as sequence of questions, and the manner in which the survey panels are closed.

The survey design interface 210 can be structured to provide accounts for individual survey designers 201. Individual survey designers 201 can design multiple projects, each corresponding to a survey integrated creative that is campaigned or otherwise distributed on a network. As shown by FIG. 9A, an interface 910 is provided that identifies each project 911 by project name, status (active or inactive), size parameter 912 (indicating the dimensions of the creative) and other information. In the example shown, the user may select or sort projects by the dimension parameter 912 of the creative, particularly as the survey portion of the creative is presented in the space of the creative.

FIG. 9B illustrates an interface for enabling a survey designer to create a new project. An interface 920 includes fields for the designer to identify a name of the project, as well as other functionality to enable the designer to configure the creative of that project. In particular the content portion of the creative may be configured to display, for example, a banner advertisement or other form of promotional/commercial content. To configure the content portion, the designer can select to upload, or otherwise specify, banner ad content, flash file, image file, or other content, located on the terminal of the designer or on a room location accessible to the survey design interface 210 over the network. Other fields on the interface 920 enable the survey designers to specify how for example the creative is to start when rendered on a webpage. For example, the survey designer may specify the invitation panel, all are in the example shown, in audible that define how the project starts (with or without sound). Still further, in some implementations, the survey designer can use the interface 920 to design or otherwise configure survey questions in the creative. Other configurations include for example, specifying the registration of the creative, and configuring the end screen (the last panel shown to the user; see e.g. FIG. 5H). The interface 920 also enables the user to view and interact with a preview of the creative in progress, using input provided from the user.

FIG. 9C illustrates a panel for enabling the survey designer to specify input of designing the content portion of the creative. With panel 930, the survey designer can specify a parametric value 931 for designating content that is to be rendered in the beginning sequence or duration of the creative. The panel 930 also provides designation and upload interface 932, to enable the survey designer to specify an image or video file that is to occupy the beginning portion of the creative. Another parametric input 933 can be used to designate the events that are to trigger the display of questions in the survey portion of the creative. In the example shown, the survey designer can elect to display questions in response to a mouse over on the creative. Thus, the content portion of the creative (which can include a survey invitation or first survey question of the survey portion) may transition into a series or sequence of questions that comprise the survey portion of the creative.

Another parametric input 935 enables the survey designer to designate a duration in which the content portion of the creative is rendered, before the first question of the survey portion is displayed. Still further, other parametric input 937 enables the survey designer to specify a link that the end viewer can navigate to by clicking on the creative. Plus, the content portion of the creative may act like a conventional banner ad, while blending in a survey portion to analyze, for example, the effectiveness of the banner ad from a population of end viewers.

With reference to panels of FIG. 9B or FIG. 9C, a preview panel 940 may depict the survey or content portions of the creative during the design phase.

FIG. 9D illustrates the panel 930 expanded (or alternative replaced) to provide a functional interface for the user to structure the survey portion of the creative. In the example shown, a first field 942 allows the user to select the formatting template to designate the look and feel of how the questions are presented. The input can designate, for example, the backdrop on which the questions are presented, the font, and/or any other formatting or stylistic aspect of presenting the survey questions. In the example shown, other examples are input fields include opacity 943 and column input 944. A time out field 945 enables the survey designer to specify the number of seconds (or duration) in which a particular question is displayed to the user before the survey portion of the creative is terminated, or alternatively, before the unanswered question is transitioned to a next question. In input field 947 can actually specify what is to happen if the timeout is triggered (i.e. the survey question is unanswered for timeout duration specified in 945). For example input field 947 can be provided as a menu that enables a survey designed to select that upon timeout, the survey portion of the creative is to restart, or alternatively the survey portion is to terminate, show the last closing panel, or transition to a next question.

Input fields 950, 952 enable the survey designer to specify the text of an individual survey questions, as well as the set of candidate answers that the end-user can select from. A parametric input 954 can be used by the survey designer to select whether the selected user answer from the set is to be mutually exclusive (i.e. the end viewer can select only one answer) or not (i.e. the end viewer can select more than one answer). Other fields can optionally enable the survey designer to specify that the answer to that particular survey question is to be recorded, and also the type or information that is to be recorded for particular answer or for the question as a whole. Input field 960 illustrates that the survey designer can specify the type of interaction the end viewer can have with the candidate answers (e.g. radio buttons from which the user can select by clicking or hovering, checkbox etc.).

With reference to embodiments described, the designer may alternatively specify that some or all of the survey questions or candidate answers (which are presented as text) are provided in an image data format.

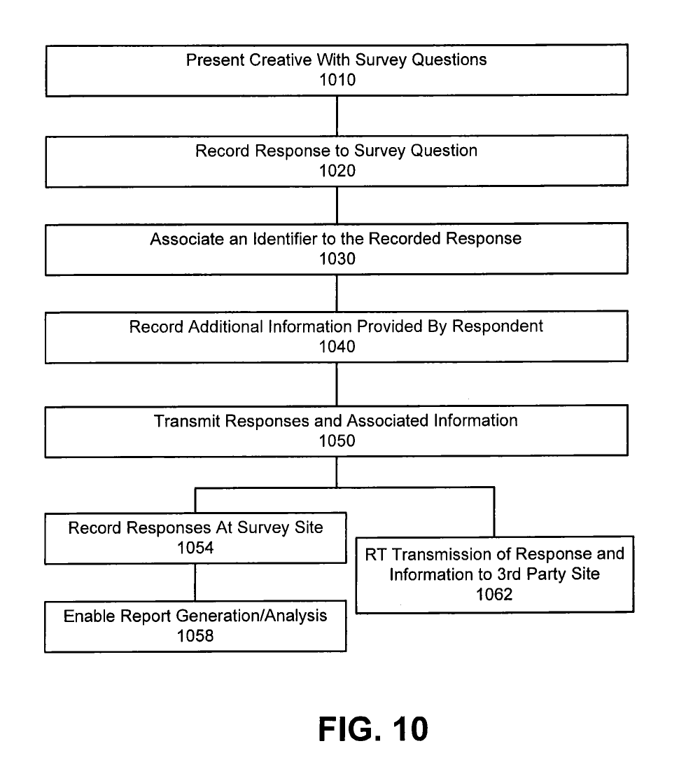

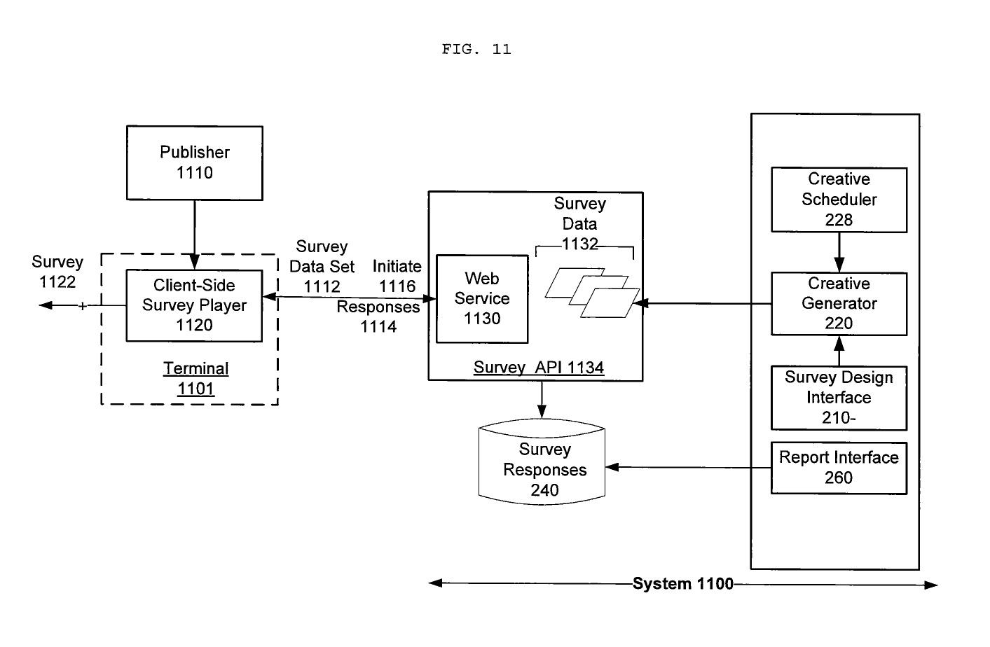

FIG. 9E illustrates functionality to enable the survey designer to allow user's to register as respondents. In an embodiment, the survey designer can specify fields that the user can enter and from which the user becomes registered. The designer may also specify a location or site that handles respondent registration. As described with an embodiment of FIG. 10, registration may provide an alternative mechanism by which user identification and association takes place. For example, a registered respondent may associate his answer to past answers.

FIG. 9F shows the panel 930 expanded (or replaced) to enable the survey designer to specify what is to happen after the survey portion of the creative ends. As examples, they creative may restart so that the content portion is depicted again after the survey portion ends. If the user participates in the survey, a thank you message or registration information may be depicted to the end viewer. Still further, the creative may simply go blank or terminate and be close on the webpage. Numerous other variations are also possible.

FIG. 9G shows that an example of how the survey design interface can maintain a tag for enabling the user to distribute or traffic creatives on the network. In an embodiment, the survey designer can access the interface, after the creative with input, and/or view the tag for the creative. By viewing the tag, the user can copy the tag onto a trafficking service, or onto a publisher website.

Recording Survey Results

As described elsewhere, embodiments described herein monitor results from the trafficking and use of survey integrated creatives. With reference to an embodiment of FIG. 2, survey player 230 includes functionality for recording interactions of end viewers. According to embodiments, information that may be recorded from trafficking and monitoring creatives include: (i) question level data, provided when a user interaction includes answering survey questions; and (ii) meta-transactional data.

The question level data can be recorded by survey player 230. The question level data can correspond to express user interaction, such as the user affirmatively making a selection of a particular answer from a set of answers. For a given creative, the question level data includes survey responses 260, which identify the particular survey question of the creative, as well as the answer specified or selected by the respondent.

The meta-transactional data may be recorded by the survey player 230. Such data can be tallied using, for example, resources on the survey site 202. In an embodiment, the meta-transactional data identifies specific pre-determined survey events as the events occur on a network population when a campaign is trafficked. Meta-transactional data may include: (i) a count or tally of the number of requests made to have the creative rendered on a terminal (i.e. number of times a browser loads the creative);(ii) the number of instances in which the survey player 230 is triggered or loaded onto a webpage for a particular creative; (iii) the number of impressions for the creative, and (iv) the number of click-throughs or click events that trigger for example presentation of a survey portion of the creative, or navigation of the browser to a specifies link. Other meta-transactional information that can be recorded by the survey player 230 include the date and time that particular survey question was answered, and a flag parameter that indicates whether a particular end viewer completed the survey.

As an addition of variation, the survey player 230 may also record identification information from individual respondents. The identification information may include, for example, data that enables the survey response or interaction to be associated with prior responses or activities from the same terminal. While this form of identification information does not identify the person providing the survey response, the identification information can associate the response provided (or other related information) with other past responses that were generated from the same terminal. In one implementation, the indentification information is provided from a cookie that can be stored on a user's browser. Information that can be associated with a particular terminal include the number of surveys, or survey integrated creatives, that have been rendered or seen on the terminal, as well as the web browser or survey player versions used to render the creatives on those terminals.

FIG. 10 illustrates a method for obtaining and using information from presenting a survey integrated creative, according to one more embodiments. In describing an embodiment of FIG. 10, reference may be made to elements described with an embodiment of FIG. 2 for purpose of illustrating suitable elements or components for use in performing a step or sub-step being described.

A survey integrated creative is presented to a user (1010). For example, survey player 230 may operate from a network site, remote survey site 202, to present him creative and its accompanying survey questions on a given terminal that accesses a publisher website where they creative is trafficked.

A response to the survey is recorded (1020). In one embodiment, information is recorded about the respondent, including information that identifies whether the respondent answered any of the survey questions, and a particular answer that were provided by the user. The survey player 230 records the responses or interactions (e.g. “question level data”).

In addition to survey responses, one or more identifiers for the terminal or user who provides survey responses are recorded. The identifiers (i.e. identification information) can include, for example, a cookie identifier, or some other form of identification that is determined from the terminal of the end-user. As an addition of variation, the identification information includes information supplied by the user (1040), such as the user's name, e-mail address or messaging identifier, or other form of identification that is affirmatively provided from the user.

As still another alternative or addition, the information that accompanies survey responses may be dynamically inserted information supplied for sources such as the website's publisher, or another source such as an advertisement service. Examples of such information include identification of the webpage where the particular user's survey response was provided, the time and date of the survey response, and/or environmental or network conditions when the survey response was provided.

The responses and associated information are transmitted to data stores where the information is maintained (1050). In some embodiments, the survey player 230 transmits such information to the database 240 of the survey site 202 (1054). From this location, the survey site 202 can provide reports, analysis tools or other information to assist the creative designer in analyzing and understanding the data (1058).

In other embodiments or implementations, the survey player 230 transmits the survey responses and the associated information to the third party site 250 (1062). The designer may be able to select or designate a location where such real-time information is received. For example, the designer may specify a URL or network location that is to receive the survey responses and associated information. The survey player 230 may operate from the network, and/or from individual terminals where the creatives are rendered, in order to communicate the responses and the associated data to the server side database 240 or to the third party site 250 in real-time.

Client Survey Applications

FIG. 11 illustrates an architecture for a system that utilizes client survey applications to distribute survey-integrated creatives over a network (e.g. Internet), according to one or more embodiments. More specifically, a system 1100 is implemented to support a client survey application (or player) in generating interactive surveys on use terminals.

In an embodiment, a survey system includes an application program interface (API) that is configured to handle communications with a client survey application executing on a user terminal. The API includes a web service and a collection of survey data files. The web service is configured to communicate with a client survey player that executes on a respondent terminal in order to provide the client survey player with data from the collection of survey data files. The data enables the client survey application to generate an interactive survey presentation on the respondent terminal.

According to another embodiment, a client survey application (or player) is configured to operate on a user (or respondent terminal). The client survey application is configured to communicate with a web service to receive survey data. The client survey application uses the survey data to present an interactive survey in connection with the presentation of an online resource.

System 1100 includes a component to enable users of a system such as described with an embodiment of FIG. 2 (e.g., advertisers) to distribute survey-integrated creatives using a client survey player 1120. According to embodiments, survey player 1120 is implemented as a persistent or session-based application that executes on user (e.g., survey respondent) terminals 1101. The survey player 1120 can be implemented in variations that execute on different types of platforms, including browser or web-based platforms. Furthermore, the survey player 1120 can be implemented in variations that execute on devices such as laptops or desktops, mobile devices (e.g., smart phones, cellular telephony/messaging handsets), or tables.

In one embodiment, the survey player 1120 is resident on a user terminal 1101 and executes through operation of a web browser. In a variation, the survey player 1120 executes through alternative web-based applications or “web-apps”. Still further, the survey player 1120 may be implemented as a standalone application on an individual user terminal.

System 1100 may correspond to a network site combination of components that are configured to communicate with the client survey player 1120. In an embodiment, system 1100 includes components such as survey site 202 (as described previously; see FIG. 2), including creative scheduler 228, creative generator 220, and survey design interface 210.

According to one or more embodiments, system 1100 includes an application program interface (API) 1134 that enables a client-side survey player 1120 to communicate with the survey site 202 and/or network-side survey resources. The survey API 1134 includes a web service 1130 and a collection of survey data files 1132. The web service 1130 is configured to communicate with the survey player 1120 using, for example, a data exchange format such as JSON (Javascript Object Notation) JSON-P. In one implementation, the web service 1130 communicates with multiple variations of the survey player 1120, including communicating with survey players 1120 that may operate on different platforms or devices. The collection of survey files 1132 includes content (e.g., survey questions, images, video) that is to be presented as part of an interactive survey. The collection of survey files 1132 can be stored on, for example, a content delivery network or with internal resources of the system 1100.

In some embodiments, the survey player 1120 is implemented independently of system 1100. In one implementation, the survey player 1120 is implemented by instructions that reside primarily on a respondent's terminal. In a variation, the survey player 1120 is implemented through scripts or instructions that execute through a user's web browser to generate functionality as described. For example, a user terminal may download the player from a website (publisher 1110) as a session-based resource. In other implementations, some or all of the survey players 1120 are stored in permanent memory on the respondent terminal 1101, and the survey players may be launched to implement functionality as described.

Among other benefits, survey player 1120 enables users or customers of system 1100 to design various aspects of the survey player and the survey presentation output for their specific needs and design parameters. For example, an advertiser can program a survey player 1120 to generate an interactive survey 1122 on a portion of a webpage with characteristics that are specific to the user's needs. In particular, various aspects of the interactive survey may be designed by the advertiser or system client. For example, the framework of the interactive survey 1122, the user interface (or specific features thereof), and file formatting parameters can be designed by the user of the system 1100 (e.g., advertiser) in order to accommodate specific considerations that are material to that entity.

In one embodiment, the survey player 1120 is created and/or configured by a customer or user of system 1100 (e.g., an advertiser or survey designer). The survey player 1120 can utilize functionality provided through system 1100 by communicating with the survey API 1134. The survey player 1120 issues calls that are handled by the web service 1130, using data retrieved from the survey data files 1132. In one implementation, the survey player 1120 communicates a survey initiation call 1116 from which survey content and data are presented to the user. The survey initiation call 1116 can be initiated in response to various events, such as (i) the launching of the survey player on a user terminal, (ii) a particular web page or resource downloaded from a site, and/or (iii) a trigger received from a network source. As additional examples, the survey initiation call 1116 may be issued with the survey player 1120 being launched, or executed on the terminal 1201, or in response to the respondent/user opening an application that is associated with the survey player.

Still further, in one implementation, the survey player 1120 executes during user web-browsing activity by calling the web service 1130. The survey player 1120 or the web browser identifies the respondent or the browser via, for example, cookie information. The response to the survey player's call is a URL or link provided from the web service 1130. The link identifies the survey data on the network as part of the collection of survey data files 1132 (e.g., CDN).

As an addition or alternative, the survey initiation call 1116 may identify information that is needed by the survey player 1120 to generate a survey presentation 1122. In particular, the survey initiation call 1116 can identify a particular survey, set of survey questions and/or other data (e.g., opening presentation, Flash file). The survey player 1120 may also use locally stored data, such as logo images or locally stored instructions. In response to the survey initiation call 1116, the web service 1130 returns a set of survey data 1112 to the survey player 1120. The survey data 1112 is used to generate the survey presentation 1122. The set of survey data 1122 can include a set of questions/data designated for the particular survey that the survey player 1120 is to present.

In one implementation, the survey player 1120 is pre-associated with a specific survey, so that the set of survey data 1112 is pre-associated with the survey player 1120. As an alternative or variation, the survey player 1120 executes with a survey selected by the system 1100. For example, web service 1130 may execute survey selecting logic that pairs the client player 1120 with a survey data set (e.g., a set of survey questions) based on a selection process that takes into account factors such as (i) website that the user accessed, (ii) time of day, or (iii) the user profile. Still further, the advertiser may specify multiple surveys that can be used with a particular survey player and the selection logic may pair one of the sets with the particular user-based on criteria such as that specified above.

The survey player 1120 executes on the user terminal in order to generate the survey presentation 1122. As described elsewhere, survey questions may be presented to the user in a variety of ways, using different formats. For example, as mentioned with other embodiments, the interactive survey presentation 1122 may present questions that are specified by the advertiser or user through, for example, the survey design interface 210. In accordance with various prior embodiments described herein, for example, the interactive presentation may include (i) video (e.g., Flash or HTML5 rendering) (see e.g., FIG. 6), (ii) configurations for how and when a first question is to be presented, (iii) configurations for how non-response from the user is to be handled, and/or (iv) specifications as to the last panel or question. In addition, various forms of survey questions may be used, such as (i) a “single” select question, to which the user may select one answer, (ii) a “multiple” select question, for which the user may select zero or more answers, and/or (iii) an “open-ended” question, in which the user can enter a response. Some question formats may specify requirement parameters in which the respondent cannot progress in the survey without answering a question or a particular question. Various other data may be exchanged between the player 1120 and the web service 1130 when the components interact.

The interactive survey presentation 1122 also includes an interface for which the respondent is able to enter input as a response to a survey question. Survey responses 1114 originating from user input on terminal 1101 are communicated by the survey player 1120 to the web service 1130. As described with other embodiments (e.g., see FIG. 2), the survey responses can be stored in the survey response data store 240. The report interface may have access to the survey responses in order to enable an advertiser to generate reports.

Usage Examples for Survey Integrated Creatives

Numerous applications may exist for embodiments such as described. One application includes ad effectiveness studies, which measure the effectiveness of an ad campaign by comparing the survey results of users who have been exposed to the campaign with results from users who have not been exposed to the campaign. The difference between the two measurements (exposed/unexposed) is attributed to the campaign.

Another application for embodiments described herein include longitudinal studies, in which a survey clientele designs survey questions to determine how an ad campaign changes attitudes and opinions over time. In this case responses are collected throughout the campaign flight and then the results of two or more points in time are compared.

Profiling studies can also be implemented with embodiments described. In profiling studies, embodiments described can be used to gather information from users in order to enable to better understanding of the demographic makeup of the audience—independently from any particular ad campaign.

As mentioned with some embodiments, survey responses may also be gathered in real-time. The real-time survey responses may be analyzed dynamically for a variety of reasons. For example, an advertiser may include surveys with a campaign in order to measure the effectiveness of a campaign, and then make adjustments to the campaign on on-going basis while the campaign is in progress. For example, if survey responses from respondents of a particular publisher site or geographic region indicate lack of interest in the campaign, the advertiser may re-traffic the campaign to other publishers or geographic regions. Similarly, if the survey response indicates the particular creative is not of sufficient interest, the advertiser can cancel the creative from the campaign. Numerous other variations are possible to how the real-time information can be utilized by advertisers or campaigners.

Although illustrative embodiments have been described in detail herein with reference to the accompanying drawings , variations to specific embodiments and details are encompassed by this disclosure. It is intended that the scope of the invention is defined by the presented claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A survey system operable on a server that is communicatively coupled to a respondent terminal, comprising:
an application program interface exposed by the server, including a web service and a collection of survey data files;
wherein the web service is configured to communicate with a client survey player that executes on the respondent terminal in order to provide the client survey player with data from the collection of survey data files, the data enabling the client survey player to generate an interactive survey presentation displayable by a web browser executing on the respondent terminal, the client survey player being separately instantiated from the web browser so that the client survey player is operable to cause a survey integrated creative to be displayed by the web browser while the web browser is executing on the respondent terminal.

2. The survey system of claim 1, wherein the web service generates a response to a survey initiation call generated by the client survey player in response to an event.

3. The survey system of claim 2, wherein the survey data includes one or more survey questions.

4. The survey system of claim 1, further comprising a survey generator that generates data for the collection of data files based on a survey designer input.

5. The survey system of claim 1, wherein the web service is configured to communicate with the client survey player in order to receive one or more survey responses from a user of the respondent terminal.

6. The survey system of claim 5, further comprising a data store that stores the one or more survey responses, and a report interface to enable a user of the survey system to view the one or more survey responses.

7. A computer system comprising:
one or more processors;
memory, operatively coupled to the one or more processors, and arranged for holding data and instructions, the instructions implementing a web browser, and
a client survey player, the client survey player being separately instantiated from the web browser so that the client survey player is operable to cause a survey integrated creative to be displayed by the web browser when the web browser is executing on the respondent terminal, the client survey player being further configured to:
communicate with a web service to receive survey data; and
use received survey data to present an interactive survey in connection with presentation of an online resource on the web browser.

8. The computer system of claim 7, wherein the client survey application is configured to communicate one or more survey responses from an operator of the computer system to the web service.

9. The computer system of claim 7, wherein the client survey application is configured to initiate presenting the interactive survey by generating a call to the web service in response to an event on the computer system.

10. The computer system of claim 7, wherein the client survey application is configured to (i) receive a response to the call that includes survey data, and (ii) present the interactive survey using the survey data.

11. The computer system of claim 7, wherein the client survey application is configured to send data corresponding to one or more survey responses to the web service.

12. The computer system of claim 7, wherein the client survey application is configured to be executed through use of a web browser, using instructions that reside on the computer system.

13. The computer system of claim 7, wherein the client survey application is configured to be executed through use of a web application, using instructions that reside on the computer system.

14. The computer system of claim 7, wherein the client survey application is configured to be executed through use of instructions that are permanently stored on the computer system.

15. The computer system of claim 7, wherein the client survey application is downloaded by a web browser of the computer system.

16. The survey system of claim 1 in which the data further enables the client survey player to monitor launching of the web browser on the respondent terminal and to initiate display of an interactive survey presentation, via the survey integrated creative, responsively to the monitored launching.

17. The computer system of claim 7 in which the client survey player is further configured to generate the online resource according to a trigger contained on a page displayable by the web browser.

18. A survey system operable on a server that is communicatively coupled to a respondent terminal, comprising:
an application program interface exposed by the server, including a web service and a collection of survey data files;
wherein the web service is configured to communicate with a client survey player that executes on the respondent terminal in order to provide the client survey player with data from the collection of survey data files,
the data enabling the client survey player to generate an interactive survey presentation displayable by a web browser executing on the respondent terminal, and
the client survey player being separately instantiated from the web browser so that the client survey player is operative to monitor launching of the web browser on the respondent terminal and to initiate display of an interactive survey presentation, via the survey integrated creative, responsively to the monitored launching.

19. The survey system of claim 18, wherein the web service is configured to generate a response to a survey initiation call generated by the client survey player in response to an event.

20. The survey system of claim 18, further comprising a survey generator that generates data for the collection of data files based on a survey designer input.
